(19) United States
(12) Patent Application Publication
(10) Pub. No.: US 2024/0374021 A1
(43) Pub. Date: Nov. 14, 2024

(54) ROTATABLE ADJUSTING CLEANER

(71) Applicant: QIANKUN ZHAO, Nanchong (CN)

(72) Inventor: QIANKUN ZHAO, Nanchong (CN)

(21) Appl. No.: 18/325,089

(22) Filed: May 29, 2023

(30) Foreign Application Priority Data
May 8, 2023 (CN) 202321097712.0

(51) Int. Cl. A46B 5/00; A46B 13/00; A46B 13/02; F16C 11/10

(52) U.S. Cl. CPC A46B 5/0083; A46B 5/005; A46B 5/0058; A46B 5/0095; A46B 13/008; A46B 13/02; F16C 11/10; A46B 2200/30

(57) ABSTRACT

The present utility model discloses a rotatable adjusting cleaner, comprising a brush head mounting handle, a rotational handle rotatably connected to the brush head mounting handle, and a rotational adjusting mechanism provided between the brush head mounting handle and the rotational handle; by providing a rotational adjusting mechanism between the brush head mounting handle and the rotational handle, the present utility model can achieve the rotatable adjustment of the two, so as to facilitate a user to adjust the angle of the brush head according to cleaning requirements, thereby enhancing the convenience of the use of the present application

### CROSS-REFERENCE TO RELATED APPLICATIONS

This is a U.S. patent application which claims the priority and benefit of Chinese Patent Application Number 202321097712.0, filed on May 8, 2023, the disclosure of which is incorporated herein by reference in its entirety.

### TECHNICAL FIELD

The present utility model relates to the technical field of cleaners, and in particular to a rotatable adjusting cleaner.

### BACKGROUND

With the continuous development of technology, people's lives have become increasingly intelligent. In daily life, cleaning work is also becoming more intelligent and automated. For example, automatic cleaners are a type of intelligent cleaning tool, which greatly improves the convenience of cleaning. A cleaner usually includes a cleaning rod and a brush head mounted thereon, and the brush head is automatically rotated by an electric motor, which can bring great convenience to people's cleaning work. However, the brush head of existing cleaning tools cannot adjust the angle, which brings great limitations to the use of cleaners.

### SUMMARY

The present utility model provides a rotatable adjusting cleaner to solve the technical problems set forth in the background art.

The present utility model provides a rotatable adjusting cleaner, comprising a brush head mounting handle, a rotational handle rotatably connected to the brush head mounting handle, and a rotational adjusting mechanism provided between the brush head mounting handle and the rotational handle, wherein the rotational adjusting mechanism comprises an adjusting cavity provided on the rotational handle at one end connected to the brush head mounting handle, an adjusting tooth provided in the adjusting cavity, an adjusting piece abutting against the adjusting tooth, and a cooperating tooth provided on the brush head mounting handle and used in cooperation with the adjusting tooth; the adjusting tooth is provided with a first tooth row, and the cooperating tooth is provided with a second tooth row used in cooperation with the first tooth row to tightly clamp the adjusting tooth; the adjusting tooth is movable in the adjusting cavity under a pressing of the adjusting piece, and the rotational adjusting mechanism further comprises a restoring elastic member for restoring the adjusting tooth so that the adjusting tooth is engaged with the cooperating tooth.

Further, the end part of the first tooth row or the second tooth row is provided with a rotatable part, and the rotatable part is provided with a guide surface inclined toward a central axis of the rotatable part so that the first tooth row and the second tooth row can rotate relative to each other when the first tooth row or the second tooth row contacts the rotatable part of the second tooth row or the first tooth row.

Further, the side wall of the adjusting cavity is provided with a guide arm, and the adjusting tooth is provided with a guide groove used in cooperation with the guide arm.

Further, an abutment groove is provided at one end of the adjusting tooth toward the adjusting piece, and an end part of the adjusting piece can abut in the abutment groove.

Further, the brush head mounting handle is provided with an arc-shaped turning groove, and the rotational handle is provided with a turning piece inserted into the arc-shaped turning groove.

Further, a mounting seat is provided at one end of the brush head mounting handle away from the rotational handle, and a brush head is detachably mounted to the mounting seat.

Further, a fastener groove is provided on the mounting seat; a fastener having elasticity is provided on the fastener groove, the brush head is provided with a mounting cavity, and the mounting seat is inserted into the mounting cavity and fixed in the mounting cavity by an interference fit of the fastener.

Further, a rotational motor is mounted in the brush head mounting handle, and the mounting seat is connected to an output end of the rotational motor.

Further, the rotatable adjusting cleaner further comprises an extension rod detachably connected to the rotational handle, and the extension rod comprises multiple sections of sequentially connected telescopic tubes that can expand and retract.

Further, a handle is provided on the telescopic tube away from the rotational handle, and the handle is rotatably connected to the telescopic tube away from the rotational handle via a rotational damping assembly.

The beneficial effects of the present utility model are as follows: by providing a rotational adjusting mechanism between the brush head mounting handle and the rotational handle, the present utility model can achieve the rotatable adjustment of the two, so as to facilitate a user to adjust the angle of the brush head according to cleaning requirements, thereby enhancing the convenience of the use of the present utility model; in specific adjustments, by pressing the adjusting piece, the adjusting piece is made move towards the direction of the adjusting tooth for a certain distance and then comes into contact with the adjusting tooth (at this point, the elastic member is squeezed and undergoes elastic deformation), and then the adjusting tooth is pushed to move away from the adjusting piece in the adjusting cavity; therefore, the tight clamping fit between the first tooth row on the adjusting tooth and the second tooth row on the cooperating tooth is released; furthermore, the brush head mounting handle and the rotational handle can rotate relative to each other, achieving the adjustment of the brush head; after the user completes the adjustment, the pressing on the adjusting piece is released; at this time, under the elastic force of restoring the elasticity of the elastic member, the adjusting piece restores and drives the adjusting tooth to restore, causing the first tooth row on the adjusting tooth to tightly clamp with the second tooth row on the cooperating tooth again, thereby making it impossible for the rotational handle and the brush head mounting handle to rotate.

### BRIEF DESCRIPTION OF DRAWINGS

FIG. 1 is a perspective view of a rotatable adjusting cleaner of the present application

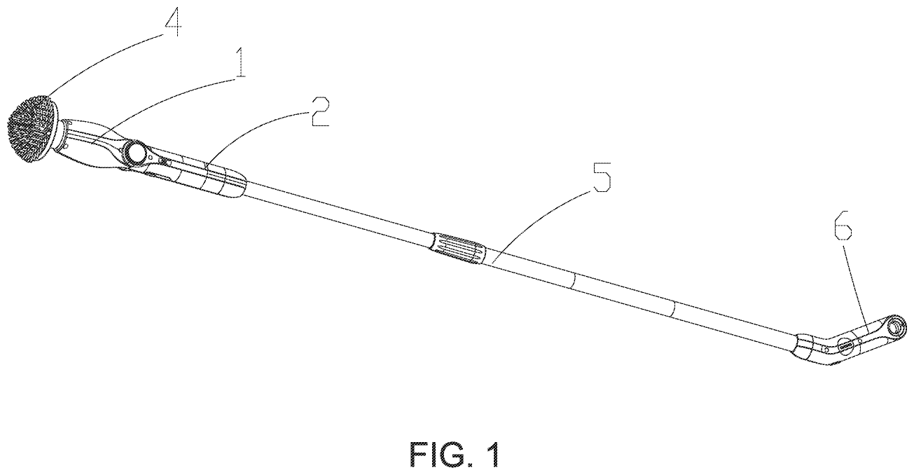

FIG. 2 is a perspective view of a hidden extension rod and handle of the present application

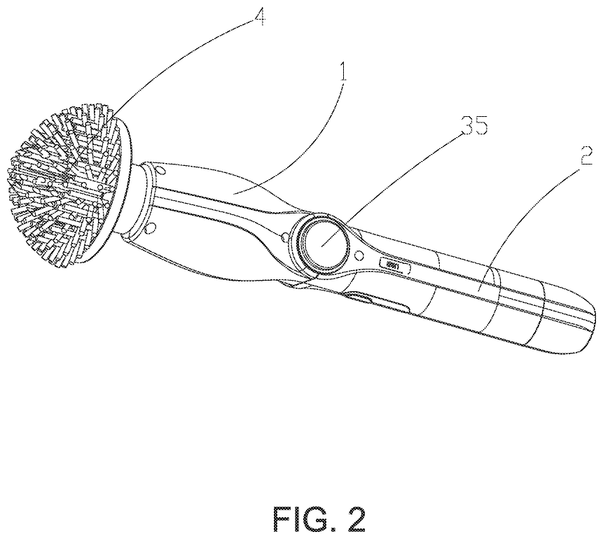

FIG. 3 is a schematic view of a tooth moving cavity of the present application

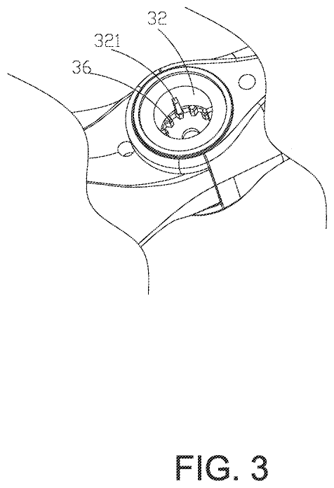

FIG. 4 is a schematic view of an adjusting piece moving cavity of the present application

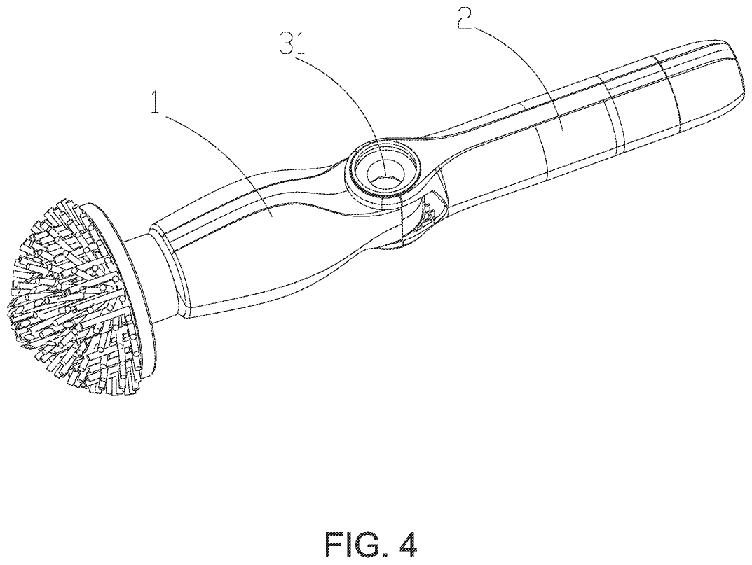

FIG. 5 is a perspective view of a brush head mounting handle of the present application

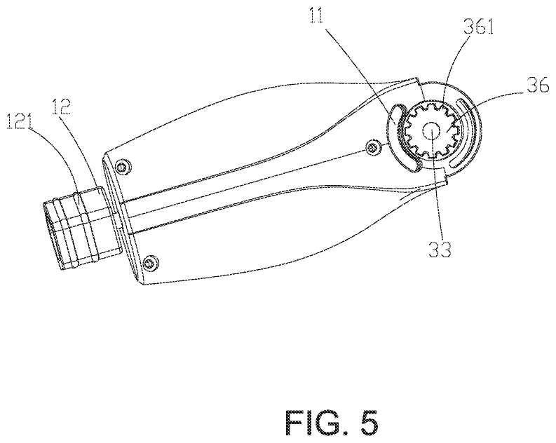

FIG. 6 is a perspective view of a rotational handle of the present application

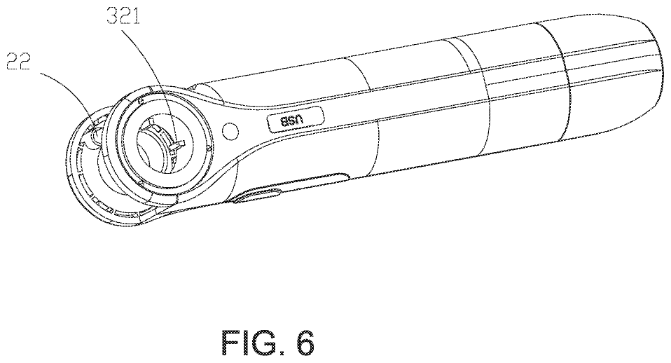

FIG. 7 is an exploded view of a rotational handle and a brush head mounting handle, and a rotating adjusting mechanism of the present application

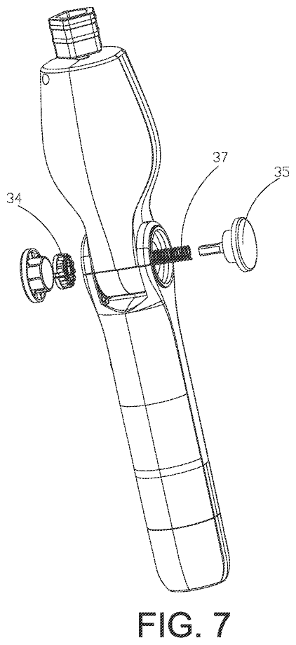

FIG. 8 is a perspective view of a brush head of the present application

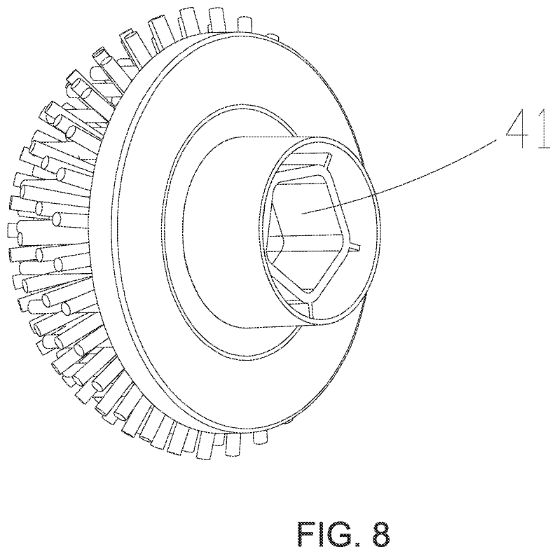

FIG. 9 is a perspective view of an adjusting tooth of the present application

FIG. 10 is another perspective view of an adjusting tooth of the present application

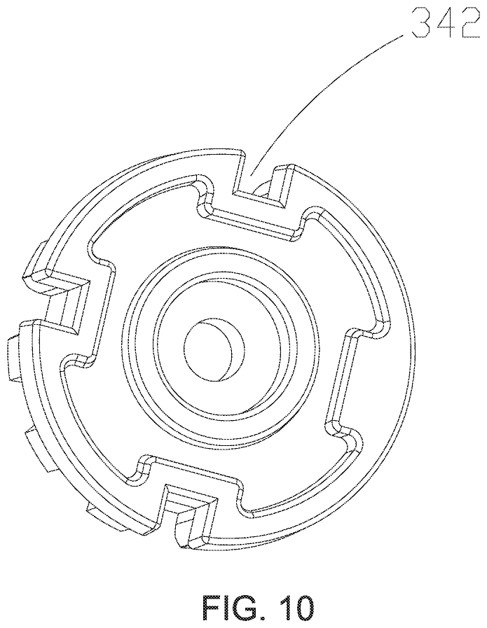

FIG. 11 is a view showing one embodiment of the present utility model in which a guide surface is provided on the second tooth row.

FIG. 12 is an exploded view of a handle and rotational damping assembly of the present application

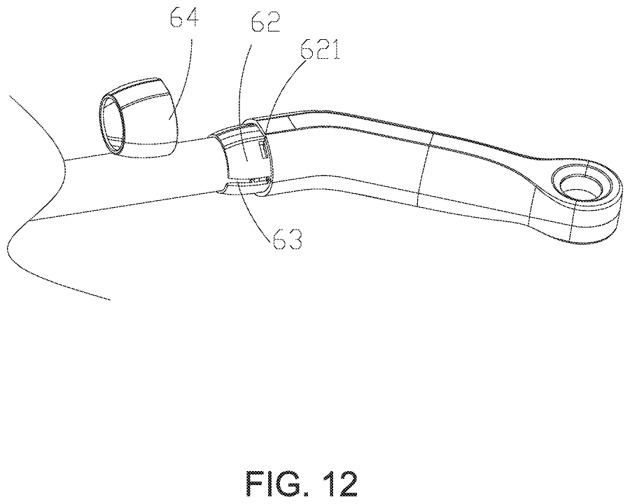

FIG. 13 is another exploded view of a handle and rotational damping assembly of the present application

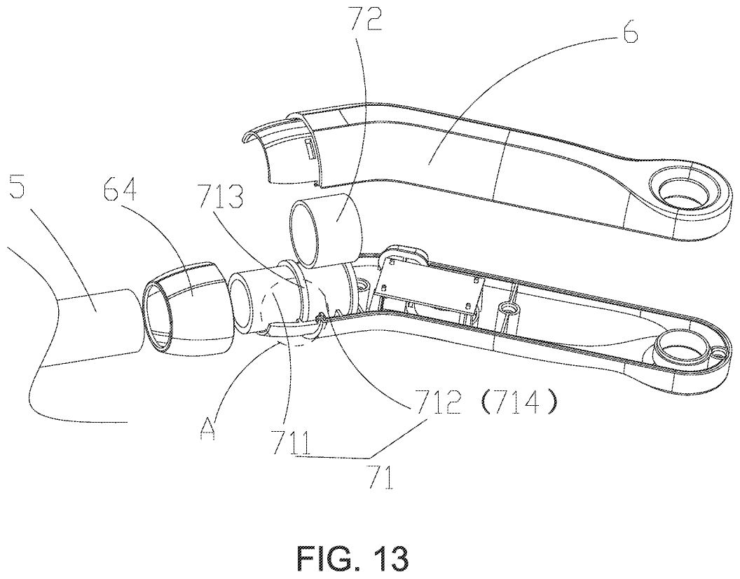

FIG. 14 is an enlarged view of portion A of the FIG. 13.

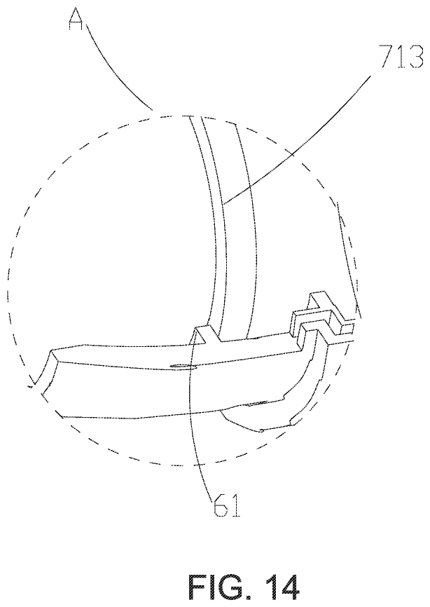

### DETAILED DESCRIPTION

Reference will now be made in detail to the embodiments of the present utility model, examples of which are illustrated in the accompanying drawings. Like or similar reference numerals refer to the same or similar elements or have elements with the same or similar functionality throughout the text. The embodiments described below by reference to the drawings are exemplary and are intended to be illustrative of the present utility model and are not to be construed as limiting the present application

Hereinafter, the present utility model will be described in further detail by specific implementation modes in conjunction with the accompanying drawings 1-14.

The present utility model provides a rotatable adjusting cleaner, including a brush head 4 mounting handle 1, a rotational handle 2 rotatably connected to the brush head 4 mounting handle 1, and a rotational adjusting mechanism provided between the brush head 4 mounting handle 1 and the rotational handle 2; the rotational adjusting mechanism comprises an adjusting cavity provided on the rotational handle 2 at one end connected to the brush head 4 mounting handle 1, an adjusting tooth 34 provided in the adjusting cavity, an adjusting piece 35 abutting against the adjusting tooth 34, and a cooperating tooth 36 provided on the brush head 4 mounting handle 1 and used in cooperation with the adjusting tooth 34; the adjusting tooth 34 is provided with a first tooth row 341, and the cooperating tooth 36 is provided with a second tooth row 361 used in cooperation with the first tooth row 341 to tightly clamp the adjusting tooth 34; the adjusting tooth 34 is movable in the adjusting cavity under the pressing of the adjusting piece 35, and the rotational adjusting mechanism further comprises a restoring elastic member 37 for restoring the adjusting tooth 34 so that the adjusting tooth 34 is engaged with the cooperating tooth 36.

In this embodiment, a rotational adjusting mechanism is provided between the brush head 4 mounting handle 1 and the rotational handle 2 so as to achieve rotatable adjustment of the two, making it convenient for users to adjust the angle of the brush head 4 according to cleaning needs, thereby enhancing the convenience of the use of the present application Specifically, when adjusting, by pressing the adjusting piece 35, the adjusting piece 35 is enabled to push the adjusting tooth 34 to move in the adjusting cavity in a direction away from the adjusting piece 35 (squeezing the elastic member 37 during the movement of the adjusting piece 35 causes elastic deformation of the elastic member 37), thereby releasing the tight clamping fit between the first tooth row 341 on the adjusting tooth 34 and the second tooth row 361 on the cooperating tooth 36. Furthermore, the brush head 4 mounting handle 1 and the rotational handle 2 can rotate relative to each other, achieving the adjustment of the brush head 4. After the user completes the adjustment, the pressing on the adjusting piece 35 is released. At this time, under the elastic force of restoring the elasticity of the elastic member 37, the adjusting piece 35 restores and drives the adjusting tooth 34 to restore, causing the first tooth row 341 on the adjusting tooth 34 to tightly clamp with the second tooth row 361 on the cooperating tooth 36 again, thereby making it impossible for the rotational handle 2 and the brush head 4 mounting handle 1 to rotate.

In a specific embodiment, the middle part of the adjusting cavity is provided with an insertion and avoidance part for inserting the brush head 4 mounting handle 1. The brush head 4 mounting handle 1 is inserted into part of the insertion and avoidance part to divide the adjusting cavity into a tooth moving cavity 32 and an adjusting piece moving cavity 31, the two are in communication via an adjusting hole 33, the adjusting tooth 34 is arranged in the adjusting piece 35 moving cavity, and the adjusting piece 35 is arranged in the adjusting piece moving cavity such that the adjusting piece 35 can pass through the adjusting hole 33 to enter the tooth moving cavity 32 and push the adjusting tooth 34 to move. In this embodiment, it may also be provided between the bottom wall of the tooth moving cavity 32 remote from the adjusting piece moving cavity 31 and the adjusting tooth 34.

In an alternative embodiment, the elastic member 37 can be arranged between the bottom wall of the adjusting cavity remote from the adjusting piece 35 and the adjusting tooth 34. When it is necessary to adjust the angle of the brush head 4, the adjusting piece 35 is pressed so that the adjusting piece 35 pushes the adjusting tooth 34 to move in the adjusting cavity away from the adjusting piece 35 (at this time, the elastic member 37 is compressed and sends an elastic deformation), thereby releasing the tight clamping fit between the first tooth row 341 on the adjusting tooth 34 and the second tooth row 361 on the cooperating tooth 36. Furthermore, the brush head 4 mounting handle 1 and the rotational handle 2 can rotate relative to each other, so as to adjust the brush head 4.

In an alternative embodiment, the elastic member 37 may be provided between the bottom wall of the adjusting piece moving cavity 31 close to the tooth moving cavity 32 and the adjusting piece 35. When the adjusting piece 35 is pressed to move in the direction of the tooth moving cavity 32, the elastic member 37 is squeezed and elastically deforms, so that the pressing on the adjusting piece 35 is released after the user finishes adjusting, and at this time, the adjusting piece 35 is restored under the elastic force of the elastic member 37 restoring elasticity and drives the adjusting tooth 34 to restore. Therefore, the first tooth row 341 on the adjusting teeth 34 and the second tooth row 361 on the cooperating tooth 36 are tightly clamped again, so that the rotational handle 2 and the brush head 4 mounting handle 1 cannot rotate.

In a specific embodiment, the adjusting piece 35 comprises an adjusting pressing part and an adjusting part connected to the adjusting pressing part, and the cross-section of the adjusting piece 35 is T-shaped.

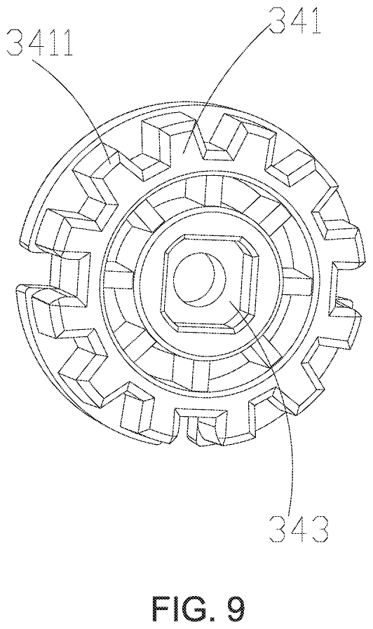

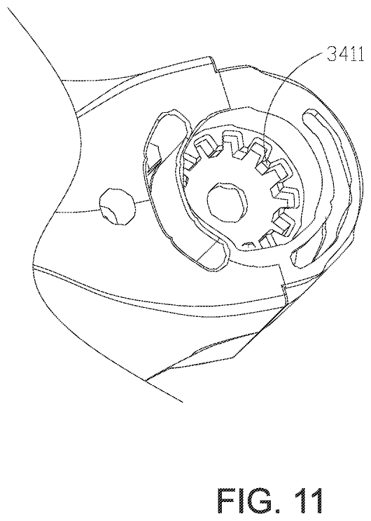

In a specific embodiment, an end part of the first tooth row 341 or the second tooth row 361 is provided with a rotatable part. The rotatable part is provided with a guide surface 3411 inclined towards the central axis of the rotatable part, so that when the first tooth row 341 or the second tooth row 361 contacts the rotatable part of the second tooth row 361 or the first tooth row 341, the first tooth row 341 and the second tooth row 361 can rotate relative to each other. In this embodiment, by providing an inclined guide surface 3411 at the end part of the upper adjusting tooth of the first tooth row 341 or the second tooth row 361 (as shown in FIG. 9 or FIG. 11, where the guide surface is provided on the first tooth row in FIG. 9 and the guide surface is provided on the second tooth row in FIG. 11), the first tooth row 341 and the second tooth row 361 can rotate relative to each other even in contact, and there is a certain resistance to the rotation. That is, when adjusting the brush head 4, it requires the user to rotate it to achieve the effect so as to generate a sense of sophistication and improve the user experience. In this embodiment, in order to make the user press the adjusting piece 35 to push the adjusting tooth 34 to move without separating the first tooth row 341 from the second tooth row 361, only a stop flange or stopper needs to be provided on the side wall of the tooth moving cavity 32. Therefore, when the adjusting tooth 34 moves to the position of the stopper or stop flange, the adjusting tooth 34 is hindered by the stopper or stop flange and cannot continue to move. At this time, the rotatable part of the first tooth row 341 or the second tooth row 361 just contacts the second tooth row 361 or the first tooth row 341, so that it can provide a sense of gear when rotating.

In a specific embodiment, the side wall of the adjusting cavity is provided with a guide arm 321, the adjusting tooth 34 is provided with a guide groove 342 used in cooperation with the guide arm 321, the adjusting tooth 34 can move smoothly in the adjusting cavity by the cooperation of the guide arm 321 and the guide groove 342, and the adjusting tooth 34 cannot rotate in the adjusting cavity by the cooperation of the guide arm 321 and the guide groove 342. Therefore, in the case where the adjusting tooth 34 is tightly clamped with the cooperating tooth 36, the brush head 4 mounting handle 1 and the rotational handle 2 do not rotate. Specifically, the guide arms 321 and the guide grooves 342 are both multiple and of the same number, so that the smoothness of the movement of the adjusting tooth 34 can be further improved.

In a specific embodiment, the adjusting tooth 34 is provided with an abutment groove 343 towards one end of the adjusting piece 35, the end part of the adjusting piece 35 being able to abut in the abutment groove 343, so that the adjusting piece 35, under the pressure of a user, can abut against the bottom wall of the abutment groove 343, thereby pushing the adjusting tooth 34 to move.

In a specific embodiment, the brush head 4 mounting handle 1 is provided with an arc-shaped turning groove 11, and the rotational handle 2 is provided with a turning piece 22 inserted into the arc-shaped turning groove 11. By cooperating the arc-shaped turning groove 11 with the turning piece 22, it is possible to improve the guiding effect for the turning of both.

In a specific embodiment, one end of the brush head 4 mounting handle 1 remote from the rotational handle 2 is provided with a mounting seat 12 on which the brush head 4 is detachably mounted, and the mounting seat 12 is detachably mounted with the brush head 4, so that different brush heads 4 can be replaced and the cleaning of the brush head 4 is facilitated.

In a specific embodiment, the mounting seat 12 is provided with a fastener groove; an elastic fastener 121 is provided on the fastener groove, the brush head 4 is provided with a mounting cavity 41, the mounting seat 12 is inserted into the mounting cavity 41 and fixed in the mounting cavity 41 by an interference fit of the fastener 121, and the fastener 121 is made of an elastic material such as silica gel or rubber, so that when the brush head 4 is inserted and fitted with the mounting seat 12, and the fastener 121 can be squeezed so as to realize the insertion and fixing of the two. When the brush head 4 is inserted and fitted with the mounting seat 12, the existence of the fastener groove enables the fastener 121 to be held in the fastener groove without moving randomly.

In a specific embodiment, a rotational motor is mounted in the brush head 4 mounting handle 1, the mounting seat 12 is connected to an output end of the rotational motor, and the rotation of the mounting seat 12 can be controlled by the rotational motor, so that automatic rotation of the brush head 4 can be achieved, and thus automatic cleaning operation of the brush head 4 can be achieved. A controller for controlling the rotation of the rotational motor and a battery for powering the rotational motor are provided on the brush head 4 mounting handle 1 or the rotational handle 2.

In a specific embodiment, the rotatable adjusting cleaner further comprises an extension rod 5 detachably connected to the rotational handle 2 so as to increase the length of the rotatable adjusting cleaner for cleaning high places. The rotational handle 2 is provided with a threaded cavity, and the extension rod 5 is provided with threads so as to realize the threaded connection of the rotational handle 2 and the reinforcing rod.

In a specific embodiment, the extension rod 5 comprises multiple sections of sequentially connected telescopic tubes that can expand and retract. A handle 6 is provided on the telescopic tube away from the rotational handle 2. It can be seen from the multiple sections of telescopic tubes that the adjustment of the length of the extension rod 5 is achieved. The handle 6 can make it convenient for an operator to hold the rotatable adjusting cleaner of the present application

In a specific embodiment, the handle 6 is rotatably connected to a telescopic tube remote from the rotational handle 2 (for the convenience of description, the telescopic tube remote from the rotational handle is hereinafter referred to as a sleeve jointing tube) via a rotating damping assembly. The rotational damping assembly comprises a rotating sleeve 71 sleeved on the sleeve jointing tube and a damping sleeve 72 sleeved on the rotational sleeve 71, and the rotational sleeve 71 comprises a connecting end 711 fixedly connected to the sleeve jointing tube and a sleeve jointing end 712 sleeved on the damping sleeve 72 in a relatively rotatable manner. The connecting end 711 is arranged concentrically with the sleeve jointing end 712, and the diameter of the connecting end 711 is smaller than the diameter of the sleeve jointing end 712, so that the position where the connecting end 711 is connected with the sleeve jointing end 712 has a step surface 713. The sleeve jointing end 712 is provided with a sleeve jointing groove 714 for sleeve jointing the damping sleeve 72, an accommodating cavity for accommodating and abutting against the damping sleeve 72 is provided in the handle 6, and the accommodating cavity is provided with a penetrating-out hole for penetrating out the connecting end 711; the step surface 713 is located in the accommodating cavity and abuts against a side wall 61 of the accommodating cavity which is coplanar with the penetrating-out hole, so that the rotating damping assembly can be confined in the handle 6; the rotating sleeve 71 can rotate with respect to the damping sleeve 72, so that the extension rod 5 can rotate with respect to the handle 6, and after a user has adjusted the angle of the brush head 4, a suitable cleaning angle can be adjusted by rotating the handle 6, so as to improve the flexibility of the use; furthermore, the handle 6 is further provided with a clamping part 62 extending from the accommodating cavity to the direction of the extension rod 5; the clamping part 62 is made of an elastic material and clamps the sleeve jointing tube, so that the sleeve jointing tube can be prevented from rotating relative to the handle 6 under the effect of no force applied by a user; the clamping part 62 is provided with multiple openings 63 at intervals; the handle is further provided with a sleeve jointing piece 64 for gathering the clamping part 62 towards the middle to clamp the sleeve jointing tube; multiple clamping pieces are provided in the sleeve jointing piece 64; the clamping part 62 is provided with a clamping groove 621 cooperating with the clamping piece, and the clamping piece cooperates with the clamping groove 621 such that the engagement between the sleeve jointing piece 64 and the clamping part 62 is achieved.

What is claimed is:

1. A rotatable adjusting cleaner, characterized by comprising a brush head mounting handle, a rotational handle rotatably connected to the brush head mounting handle, and a rotational adjusting mechanism provided between the brush head mounting handle and the rotational handle, wherein the rotational adjusting mechanism comprises an adjusting cavity provided on the rotational handle at one end connected to the brush head mounting handle, an adjusting tooth provided in the adjusting cavity, an adjusting piece abutting against the adjusting tooth, and a cooperating tooth provided on the brush head mounting handle and used in cooperation with the adjusting tooth; the adjusting tooth is provided with a first tooth row, and the cooperating tooth is provided with a second tooth row used in cooperation with the first tooth row to tightly clamp the adjusting tooth; the adjusting tooth is movable in the adjusting cavity under a pressing of the adjusting piece, and the rotational adjusting mechanism further comprises a restoring elastic member for restoring the adjusting tooth so that the adjusting tooth is engaged with the cooperating tooth.

2. The rotatable adjusting cleaner according to claim 1, characterized in that an end part of the first tooth row or the second tooth row is provided with a rotatable part, and the rotatable part is provided with a guide surface inclined toward a central axis of the rotatable part so that the first tooth row and the second tooth row can rotate relative to each other when the first tooth row or the second tooth row contacts the rotatable part of the second tooth row or the first tooth row.

3. The rotatable adjusting cleaner according to claim 1, characterized in that a side wall of the adjusting cavity is provided with a guide arm, and the adjusting tooth is provided with a guide groove used in cooperation with the guide arm.

4. The rotatable adjusting cleaner according to claim 1, characterized in that an abutment groove is provided at one end of the adjusting tooth toward the adjusting piece, and an end part of the adjusting piece can abut in the abutment groove.

5. The rotatable adjusting cleaner according to claim 1, characterized in that the brush head mounting handle is provided with an arc-shaped turning groove, and the rotational handle is provided with a turning piece inserted into the arc-shaped turning groove.

6. The rotatable adjusting cleaner according to claim 1, characterized in that a mounting seat is provided at one end of the brush head mounting handle away from the rotational handle, and a brush head is detachably mounted to the mounting seat.

7. The rotatable adjusting cleaner according to claim 6, characterized in that a fastener groove is provided on the mounting seat; a fastener having elasticity is provided on the fastener groove, the brush head is provided with a mounting cavity, and the mounting seat is inserted into the mounting cavity and fixed in the mounting cavity by interference fit of the fastener.

8. The rotatable adjusting cleaner according to claim 6, characterized in that a rotational motor is mounted in the brush head mounting handle, and the mounting seat is connected to an output end of the rotational motor.

9. The rotatable adjusting cleaner according to claim 1, characterized in that the rotatable adjusting cleaner further comprises an extension rod detachably connected to the rotational handle, and the extension rod comprises multiple sections of sequentially connected telescopic tubes that can expand and retract.

10. The rotatable adjusting cleaner according to claim 9, characterized in that a handle is provided on the telescopic tube away from the rotational handle, and the handle is rotatably connected to the telescopic tube away from the rotational handle via a rotational damping assembly.
